(19) United States
(12) Patent Application Publication
(10) Pub. No.: US 2023/0342342 A1
(43) Pub. Date: Oct. 26, 2023

(54) Methods, Apparatuses and Computer Program Products for Stable Identifier Assignment for Evolving Data Structures

(71) Applicant: META PLATFORMS, INC., Menlo Park, CA (US)

(72) Inventors: David Pletcher, Stateline, NV (US); Dhruv Jagdish Matani, Newark, CA (US); Manolis Karpathiotakis, Hitchin (GB); Stefan Alexandru Filip, San Carlos, CA (US); Kevin Thomas Wilfong, Menlo Park, CA (US); Sushil Dhaundiyal, Kirkland, WA (US); Chong Xie, Bellevue, WA (US); Thomas M. Lento, Menlo Park, CA (US); Md Mustafijur Rahman Faysal, Milpitas, CA (US); Pramod Nayak, San Jose, CA (US); Bharat Vaidhyanathan, Santa Clara, CA (US); Jingjing Zhang, San Diego, CA (US); Hung Duong, Palo Alto, CA (US); Dino Wernli, Zurich (CH)

(21) Appl. No.: 17/742,723

(22) Filed: May 12, 2022

(30) Foreign Application Priority Data
Apr. 26, 2022 (GR) 20220100340

(51) Int. Cl. G06F 16/21

(52) U.S. Cl. CPC G06F 16/212

(57) ABSTRACT

A system for providing identifier assignments to a schema(s) according to a binary serialization protocol is disclosed. The system may receive a first schema from a device(s). The first schema may be associated with a first data structure. The system may analyze the first schema in relation to a second schema associated with a second data structure associated with the first data structure. The system may assign, based on the second schema, identifiers to fields of the first data structure associated with the first schema to conform the first data structure to the second schema. The system may store the assigned identifiers in memory based on the second schema. The system may analyze content items corresponding to another data structure received by a network device. The system may determine whether fields of the another data structure are associated with assigned identifiers in the memory, which conform to the second schema.

### CROSS-REFERENCE TO RELATED APPLICATIONS

This application claims priority to Greek Patent Application No. 20220100340, entitled “Methods, Apparatuses and Computer Program Products for Stable Identifier Assignment for Evolving Data Structures,” filed Apr. 26, 2022, the disclosure of which is hereby incorporated by reference in its entirety.

### TECHNOLOGICAL FIELD

Exemplary embodiments of this disclosure may relate generally to methods, apparatuses and computer program products for providing a versioned and constantly evolving binary serialization protocol for transferring data across one or more systems.

### BACKGROUND

Some existing serialization systems may utilize formats for communicating data across a system that may cause the data to be perturbed. For example, systems that rely on field names for evolving payload schemas may result in a situation where the serialized data may be logged in an obsolete format in instances in which there may be data configuration changes and/or in which there may be code updates associated with the data in the system. These drawbacks may cause components associated with the data to be out of synchronization. For example, in an instance in which schemas associated with the data are unsynchronized, positionally-indexed serialization of fields in the data payload may be misinterpreted by a system, leading to data loss and corruption. Some of the data may be unrecoverable, for example, when components associated with the data are unsynchronized.

In view of the foregoing drawbacks, it may be beneficial to provide an efficient and reliable mechanism for an evolving binary serialization protocol for transferring data across one or more systems.

### BRIEF SUMMARY

Exemplary embodiments are described for enabling an efficient, stable, and flexible binary serialization protocol for providing data (e.g., data structures) across one or more systems.

The exemplary embodiments may facilitate logging of data such as, for example, messages (also referred to herein as log messages) from communication devices of a system(s) into a centralized network (e.g., a network device), to enable a compact as well as forward and backward compatible binary serialization protocol which may write messages for communication across one or more systems. Messages written by the network may be provided to one or more communication devices for processing and/or consumption. The binary serialization protocol utilized by the exemplary embodiments may also permit schema evolution efficiently. For example, the binary serialization protocol may allow evolution of a schema with minimal system overhead during serialization and deserialization of older (or newer) data payloads. Neither a reader device nor a writer device of older (or newer) messages need to incur a runtime penalty by deserializing/serializing the messages since the reader and writer devices may be producing or consuming a payload for a new schema that may not be a current schema.

The messages generated by the binary serialization protocol utilized by the exemplary embodiments may be in a binary format for maximum efficiency pertaining to, for example, runtime as well as size of the messages. The binary format may be any efficient binary serialized format (e.g., a format that may not convert numbers and fields into plain text). The messages being in binary format (as opposed to plain text) may enable computing devices to more efficiently process the messages. The binary serialization protocol utilized by the exemplary embodiments may provide backward compatibility such that older messages may be executed/replayed and understood by the centralized network (e.g., a network device). Additionally, the binary serialization protocol utilized by the exemplary embodiments may provide forward compatibility such that newer messages (e.g., produced by a newer version of the protocol) may be, at least, partially understood by the centralized network.

The fulfillment of these properties by the binary serialization protocol utilized by the exemplary embodiments may result in a flexible and evolving schema for data transfer across one or more systems. The binary serialization protocol utilized by the exemplary embodiments may be applicable for any system(s) in which a binary data transfer protocol may be desirable.

A network device associated with the exemplary embodiments may receive one or more schemas for named data structures (also referred to herein as structs) from a communication device(s) associated with a user during a schema specification phase. In some example embodiments, the one or more schemas may be specified/defined, in part, by the user (e.g., a developer) for example during the schema specification phase. The one or more schemas may be associated with a named struct(s). The network device may analyze the one or more schemas associated with the named struct(s) and may apply a determined second schema associated with a binary serialization protocol to assign identifiers to one or more fields in the one or more schemas. The network device may facilitate storage of the assigned identifiers in a memory device based on the determined second schema which may include assigned stable identifiers for each of the fields in the one or more schemas. The network device may receive content items from at least one communication device. The content items may be serialized by utilizing a binary serialization protocol by referencing the determined second schema (e.g., and the identifiers) for each of the fields in the received content items. In some example embodiments, the content items may, but need not, be associated with payload data (e.g., messages).

In one example embodiment, a method for providing identifier assignments to a schema(s) according to a binary serialization protocol is provided. The method may include receiving, by a network device, a first schema from a communication device(s). The first schema may be associated with a first named data structure. The method may further include analyzing the first schema in relation to a second schema associated with a second named data structure. The second named data structure may be associated with the first named data structure. The second schema may be generated by the network device. The method may further include assigning, based on the second schema, numeric identifiers to one or more fields of the first named data structure associated with the first schema to conform the first named data structure to the second schema, resulting in assigned numeric identifiers. The method may further include facilitating storage of the assigned numeric identifiers in a memory device based on the second schema. The method may further include analyzing one or more content items corresponding to another named data structure received by the network device. The method may further include determining whether one or more fields of the another named data structure are associated with the assigned numeric identifiers in the memory device, which conform to the second schema.

In another example embodiment, a system for providing identifier assignments to a schema(s) according to a binary serialization protocol is provided. The system may include a device including one or more processors and a memory including computer program code instructions. The memory and computer program code instructions are configured to, with at least one of the processors, cause the device to at least perform operations including receiving a first schema from a communication device(s). The first schema may be associated with a first named data structure. The memory and computer program code are also configured to, with the processor, cause the device to analyze the first schema in relation to a second schema associated with a second named data structure. The second named data structure may be associated with the first named data structure. The second schema may be generated by the device. The memory and computer program code are also configured to, with the processor, cause the device to assign, based on the second schema, numeric identifiers to one or more fields of the first named data structure associated with the first schema to conform the first named data structure to the second schema, resulting in assigned numeric identifiers. The memory and computer program code are also configured to, with the processor, cause the device to facilitate storage of the assigned numeric identifiers in the memory based on the second schema. The memory and computer program code are also configured to, with the processor, cause the device to analyze one or more content items corresponding to another named data structure received by the device. The memory and computer program code are also configured to, with the processor, cause the device to determine whether one or more fields of the another named data structure are associated with the assigned numeric identifiers in the memory, which conform to the second schema.

In yet another example embodiment, a computer program product for providing identifier assignments to a schema(s) according to a binary serialization protocol is provided. The computer program product includes at least one computer-readable storage medium having computer-executable program code instructions stored therein. The computer-executable program code instructions may include program code instructions configured to receive, by a network device, a first schema from a communication device(s). The first schema may be associated with a first named data structure. The computer program product may further include program code instructions configured to analyze the first schema in relation to a second schema associated with a second named data structure. The second named data structure may be associated with the first named data structure. The second schema may be generated by the network device. The computer program product may further include program code instructions configured to assign, based on the second schema, numeric identifiers to one or more fields of the first named data structure associated with the first schema to conform the first named data structure to the second schema, resulting in assigned numeric identifiers. The computer program product may further include program code instructions configured to facilitate storage of the assigned numeric identifiers in the computer-readable storage medium or a memory device based on the second schema. The computer program product may further include program code instructions configured to analyze one or more content items corresponding to another named data structure received by the network device. The computer program product may further include program code instructions configured to determine whether one or more fields of the another named data structure are associated with the assigned numeric identifiers in the computer-readable storage medium or the memory device, which conform to the second schema.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an exemplary embodiment.

FIG. 2 is a diagram of an exemplary communication device in accordance with an exemplary embodiment.

FIG. 3 is a diagram of an exemplary computing system in accordance with an exemplary embodiment.

FIG. 4 is a diagram illustrating an identifier assignment based on a binary serialization protocol in accordance with an exemplary embodiment.

FIG. 5 is a diagram illustrating another identifier assignment based on a binary serialization protocol in accordance with another exemplary embodiment.

FIG. 6 is a diagram of a process for providing stable identifier assignments to one or more schemas according to a binary serialization protocol in accordance with an exemplary embodiment.

FIG. 7 is a diagram of another process for providing stable identifier assignments to one or more schemas according to a binary serialization protocol in accordance with another exemplary embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, messages, log messages and/or the like may, for example, be data messages (e.g., files) that may capture events that occur within, or are associated with, one or more systems and/or may be messages between communication devices within the one or more systems. In some exemplary embodiments, the messages, log messages and/or the like may, but need not, be written to a log file(s).

As referred to herein, a data structure(s), a named data structure(s), and/or a struct(s) or the like may be referred to interchangeably and may be one or more customized defined types of data. A struct(s) may include one or more fields and each field may include a unique integer identifier, a type, a name and/or an optional default value.

As referred to herein, a schema may be a logical configuration of all or a portion of data (e.g., messages). The schema may define an organization of the data in a structure/model and/or in a serialized format for storage or transfer within a system and/or storage/transfer within another system. The schema may, but need not, be defined in a computing language(s). The schema may also indicate the manner in which the data may be stored (e.g., in a memory (e.g., a database)). The schema may ensure integrity of the data being communicated by one or more devices of a system(s).

As referred to herein, a binary serialization protocol may be a transformation of a structured data payload into a sequence of bytes that may be able to reversibly encode the structured data. This transformation is efficient in the sense that it may encode the structured data into a format that is efficient to encode/decode (e.g., which facilitates processing efficiency of a computing device) and may conserve usage of bytes (e.g., which facilitates memory storage efficiency) utilized to represent the structured data.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

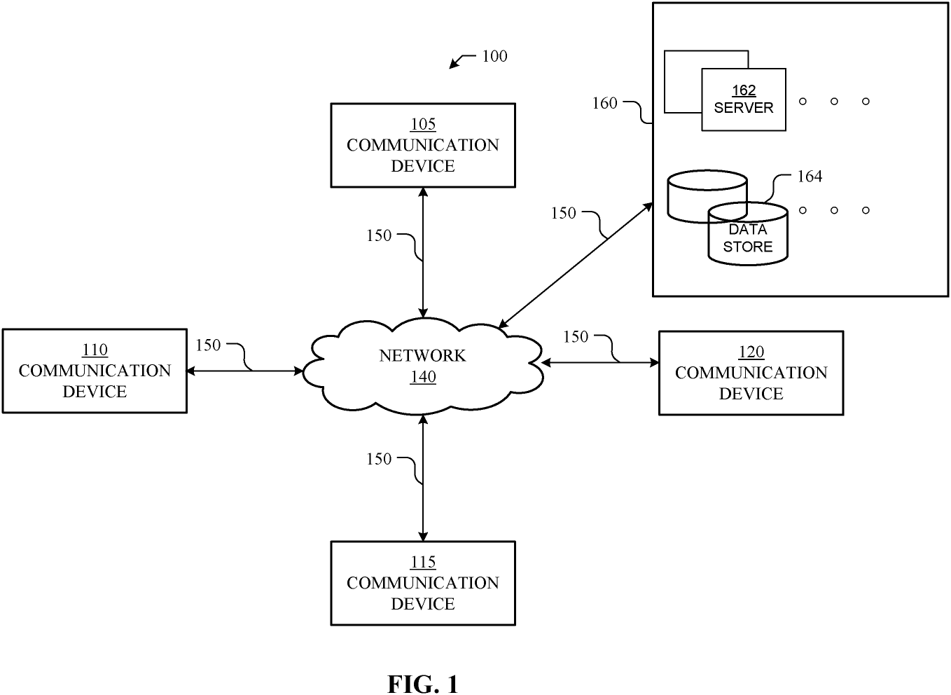

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120 any suitable number of network devices 160 and communication devices 105, 110, 115 and 120 may be part of the system of FIG. 1 without departing from the spirit and scope of the present disclosure.

### Exemplary Communication Device

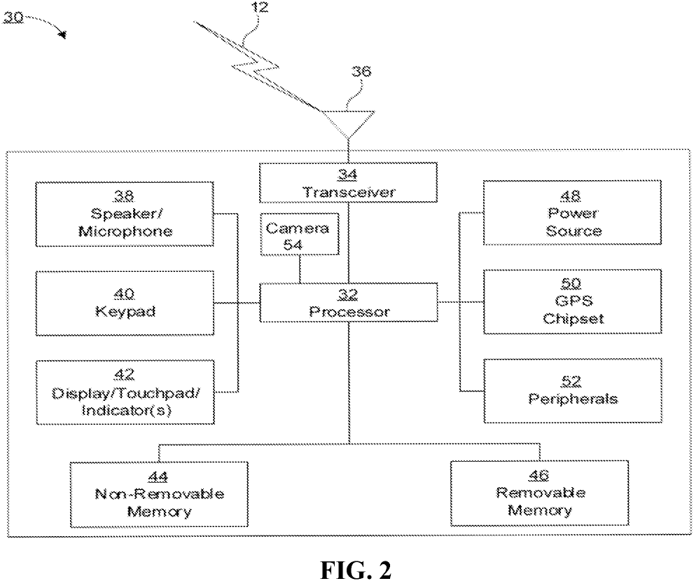

FIG. 2 illustrates a block diagram of an exemplary hardware/software architecture of a communication device such as, for example, user equipment (UE) 30. In some exemplary embodiments, the UE 30 may be any of communication devices 105, 110, 115, 120. In some exemplary embodiments, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

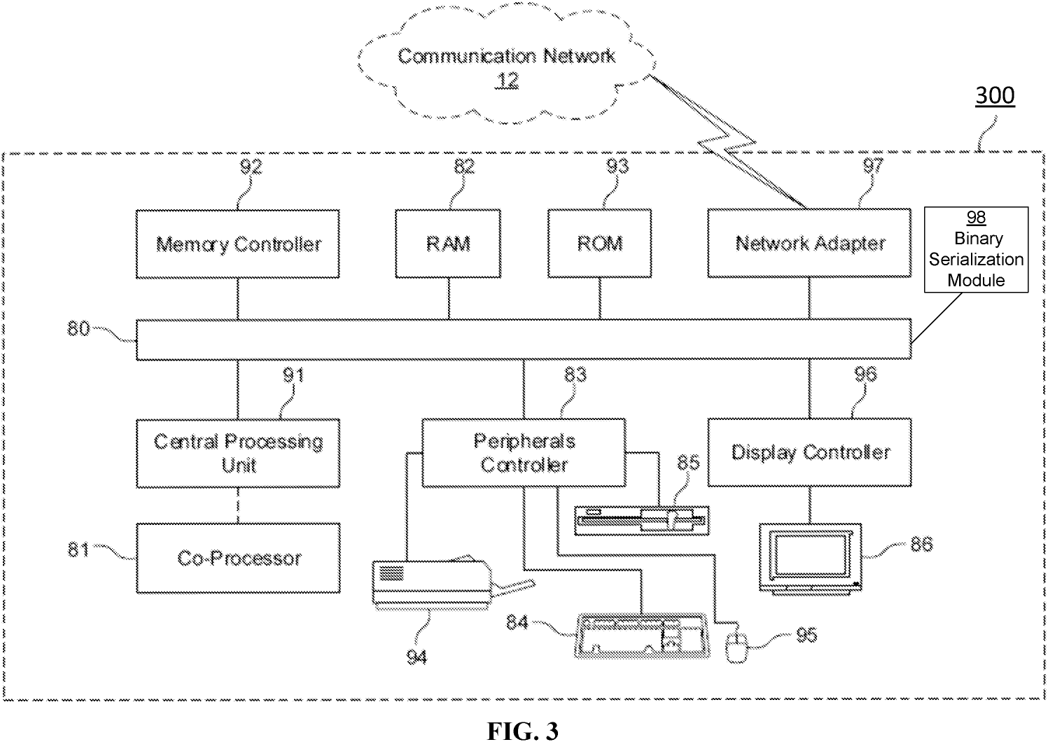

FIG. 3 is a block diagram of an exemplary computing system 300. In some exemplary embodiments, the network device 160 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer’s main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus. In an exemplary embodiment, the computing system 300 may include a binary serialization module 98. The binary serialization module 98 may utilize an identifier (ID) based binary serialization protocol associated with a data structure and may generate a schema (e.g., a model) and may assign one or more IDs to one or more fields of data messages in a stable/durable manner. In this regard, in some examples, the assigning of IDs to one or more fields of data messages, stored in a memory device, for a particular schema may not change. In other examples, the assigning of IDs to one or more fields of data messages, stored in a memory device, for a particular schema may be changed. The data structure may be composed of fields and each of the fields may have a unique integer identifier, a type, a name and/or an optional default value. The data (e.g., data structures of messages) generated by the binary serialization module 98 may be in a binary format. In this regard, based on the binary serialization module 98 utilizing the binary serialization protocol when communicating with one or more communication devices, the computing system 300 may enable the one or more communication devices to understand the data (e.g., messages) being communicated in an efficient and reliable manner.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process’s virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 300. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

### Exemplary System Operation

The exemplary embodiments may provide a stable ID assignment binary serialization protocol for data (e.g., messages) being communicated within a network (e.g., a centralized network (e.g., network device 160)) and/or provided by the network to one or more communication devices (e.g., communication devices 105, 110, 115, 120). In this manner, the communication devices may understand the data in an efficient and reliable manner, even in instances in which configurations associated with the data may be changed within a network/system(s) and/or instances in which code updates may be generated associated with the data within the network/system(s).

The exemplary embodiments may utilize a binary serialization module 98 which may assign one or more IDs to fields associated with a struct (e.g., a thrift struct) of a message(s) based in part on an associated struct definition.

The binary serialization module 98 may implement a flexible, evolving binary serialization protocol for transferring data across one or more systems (e.g., system 100). The binary serialization module 98 may permit backward compatibility (e.g., execution/replay of older/prior messages and/or understanding of older/prior messages) and forward compatibility (e.g., at least partially understand newer messages).

The binary serialization module 98 may combine an ID-based serialization protocol (e.g., thrift protocol, protocol buffers) with a stable, recursive assignment of IDs to fields within a schema. The serialization protocol may be a set of steps for converting a structured object in memory into a sequence of bytes that may be stored, for example, in a file and/or sent across a network such that the converted structured object may subsequently be converted back into the original structured object. For example, the serialization protocol may be a process for translating data structures and/or object states into a format that may be stored (e.g., in a file or memory data buffer) and/or transmitted (e.g., across a computer network/system) and may be reconstructed subsequently (e.g., within a same network/system and/or a different network/system). As described herein, thrift structs/protocols and/or protocol buffers may be examples of different implementations of efficient serialization protocols. Thrift structs/protocols and/or protocol buffers may require a developer (e.g., an application developer) to define a data payload’s schema using a custom interface definition language (IDL) provided by the thrift structs/protocols and/or protocol buffers. In response to the defining of the data payload’s schema the thrift structs/protocols and/or protocol buffers may generate associated code which a developer may utilize to facilitate both serialization (e.g., convert a structured object (e.g., data object) into a byte stream) as well as deserialization (e.g., convert from a byte stream into a structured object). The ID assignment process utilized by the binary serialization module 98 may, for example, employ one or more of the following predefined rules.

1) Stability/Backward Support: When a field with the same name exists within the older version of the schema and has the same type (or both are composite data types or struct types), an associated ID(s) may be re-used. For example, the binary serialization module 98 may reuse an already assigned ID(s) in an instance in which the already assigned ID(s) is compatible with a field(s) with a same name and type (e.g., a data type) as a field previously assigned the ID(s) for a particular category.

2) Stability/Backward Support: When a field with the same name exists within the new schema and also in an older version of the schema but has a different type, assign a new ID, except if the field type is a struct. Consider an example in which an existing struct has a field named “age” of type “integer”, which already has an ID 4 assigned to it, and if a developer’s new schema also has a field named “age” with type “integer”, the binary serialization module 98 may reuse the ID 4 (e.g., and may not generate a new ID for this field named “age”). Consider another example in which a struct has a field named “location” including 2 values (e.g., country: 1, state: 2) and that this struct has an ID 5. Suppose, for example, a developer updates the field “location” to be a structured field with 3 values in it, namely country: 1, state: 2, city: 3. In this regard, in one example embodiment, the binary serialization module 98 may reuse the ID 5 and may not generate a new ID for this struct having field “location”. Additionally, in another example embodiment, the binary serialization module 98 may reuse the IDs for the country, state fields having ID values 1, 2, respectively, but may generate a new ID for the new field city having value 3). As another example, in an instance in which a field named “age” of type “integer” assigned ID 6 exists and a developer specifies a new field named “age”, but of type “float”, the binary serialization module 98 may generate a new ID (e.g., ID 7) for such new field named “age” of type “float”.

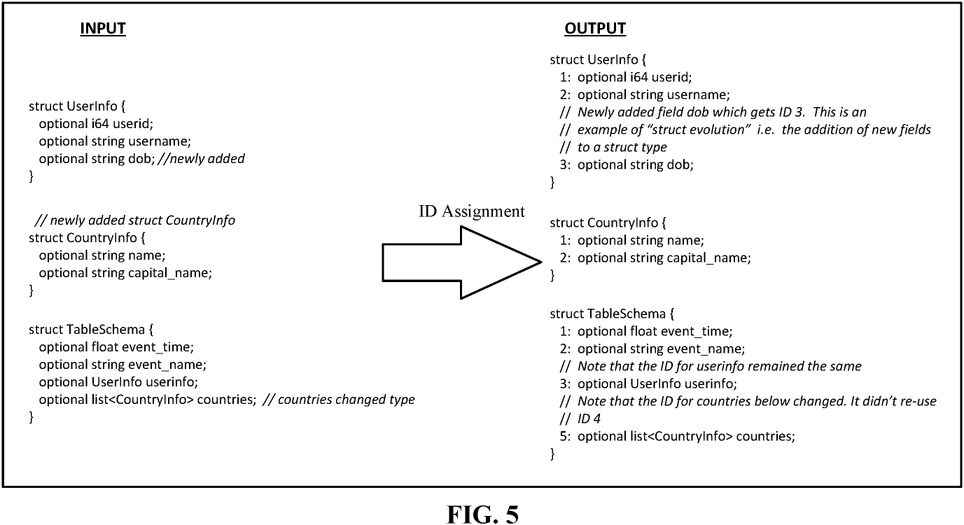

3) Recursive Assignment: When a field is a struct type being analyzed, recursively apply the assignment process to each element of the struct type. In some exemplary embodiments, a struct field may be associated with a directed acyclic graph (DAG), and each struct may have its own independent numbering namespace in a central repository such as, for example, a memory. For purposes of illustration and not of limitation, consider FIG. 5 in which the UserInfo, CountryInfo, and TableSchema structs each have their own ID space (e.g., the numbering may start from 1 for each of these structs. In some example embodiments, a struct field being associated with a DAG may denote that there may be no cycles allowed in a definition of the struct. For example, a field in the struct may not be defined as having a type that is currently in the process of being defined (e.g., another struct field of the same type). Examples of recursively defined types may be linked list nodes or a binary tree such as the following.

Struct Node {
Node *left;
Node *right;
};

In the example above, “left” and “right” may be recursively defined as type pointers to “Node”. As such, in some example embodiments, the two type pointers “left” and “right” (e.g., cycles) to “Node” may not be permitted for some structs that may be serialized by utilizing the exemplary embodiments.

4) Forward Compatibility: When a field is a new field within the schema at the current level of processing depth, assign a previously unused ID(s) for that level of processing depth. Processing depth may be associated with processing depth of nested structured fields, such as, for example, the following.

Struct LatLong {
Lat: float, (1)
Long: float, (2)
}
Struct Location {
Country: string, (1)
State: string, (2)
Coordinates: LatLong, (3)
}
Struct User {
Name: string, (1)
Loc: Location, (2)
}

In this example, LatLong is nested within Location, which itself is nested within User and these are examples of different processing depths. As such, the fields “Name”, “Country”, and “Lat” may each be assigned the same ID (e.g., ID 1) since they are at different processing depths and in a different numbering “namespace”.

5) Field Liveness: When any field exists within an old/prior schema, but not in the new schema, an associated ID may be preserved. However, the schema field may be marked as inactive.

6) Immutability: An ID once assigned may not be reused for the same level of processing depth starting from a specific named struct. However, for example, in instances in which there may be two differently named structs, these two differently named structs may be considered to be in a different ID numbering namespace, and as such the associated IDs may be reused since the struct name already identifies the unique numbering namespace for those distinct structs. Additionally, as described above, a same ID may be reused for different levels of processing depth.

The binary serialization module 98 may employ an indelible central repository such as, for example, a memory storage (e.g., RAM 82) for each of the schemas that may include the ID assignments (e.g., current and historical ID assignments) for the fields analyzed. The binary serialization module 98 may provide recursive assignment of IDs to one or more fields in an instance in which the field(s) name/type is provided. The binary serialization module 98 of the exemplary embodiments may perform the function of assigning the IDs to the fields in an instance in which a developer indicates/defines an expected schema of the data, which may occur before communication (e.g., data transfer between devices) of the data. Additionally, in an instance in which the data (e.g., payload data) associated with the schema is available (e.g., prepared by the developer), the binary serialization module 98 may serialize the data (e.g., convert a structured object into a byte stream).

Optionally, the binary serialization module 98 may bypass some of the rules of the assignment process above in instances in which there may not be a need to read previously sent messages (e.g., no backward compatibility).

In some exemplary embodiments, one or more communication devices (e.g., communication devices 105, 110, 115, 120) may provide a target schema to a centralized network, such as for example network device 160, as input. The target schema may be associated with a list, for example, of field_name, field_type pairs. The field_type itself may be a scalar such as, for example, int, string, float, boolean, etc., a collection such as, for example, list<V>, map<K, V>, set<V>, and/or a struct<...>, which itself may resemble a complex type (e.g., data type). A struct type may have named fields and as such the schema definition implemented by the binary serialization module 98 may be recursive in nature such as, for example, being associated with definitions of other structured types. For instance, in the example above, structured type “User” may be defined in terms of “Location” and structured type “Location” may be defined in terms of “LatLong”.

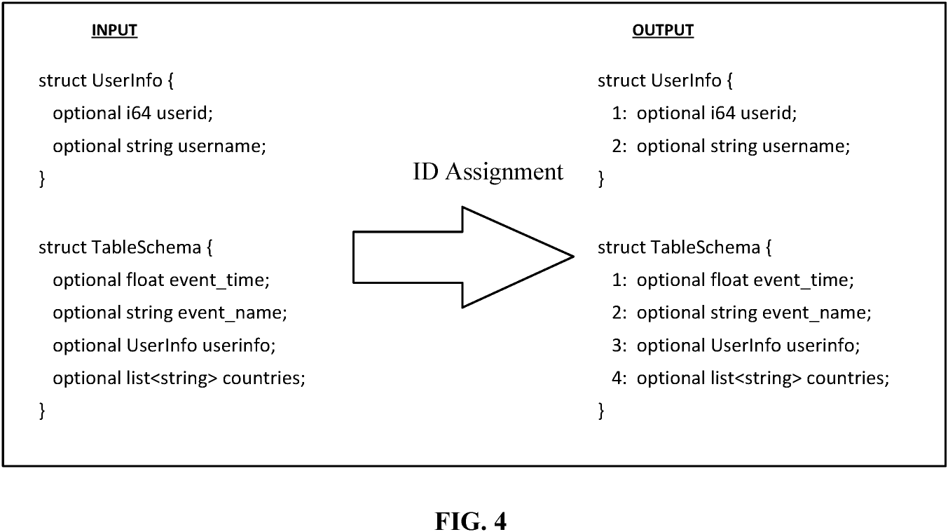

Referring now to FIG. 4, a diagram illustrating an ID assignment based on a binary serialization protocol is provided according to an exemplary embodiment. In this example of FIG. 4, consider that a centralized network device such as, for example, network device 160 may receive as an input a schema(s) (e.g., a first schema) from a node (e.g., communication device 105). The schema(s) may be associated with payload data (e.g., a message(s)) and may for example, but need not, relate one or more events occurring within a system (e.g., system 100) detected by the network device 160.

For purposes of illustration and not of limitation, payload data (e.g., a message(s)) associated with a schema may pertain to a detection of an indication of one or more users installing an application associated with a network (e.g., a social network, etc.) and/or a type of mobile device one or more users on the network may be utilizing, Internet Protocol (IP) addresses associated with the mobile devices and/or any other suitable detections (e.g., geographic regions associated with the mobile devices, etc.) within the system. As described above, the schema(s) may be processed by a node (e.g., communication device 105, communication device 110), associated with payload data (e.g., a message(s)) and the schema may be sent by the node to the network device. A user (e.g., a developer) may specify/define the schema(s) including a list of data types such as field name and field type pairs along with the name(s) of the structs associated with the schema(s).

In this example, consider that the schema processed by the node may be different than the schema (e.g., a second schema) utilized by the binary serialization module 98. As such, in response to receipt, by the network device 160, of the schema(s) (e.g., the first/input schema) from the node(s), the binary serialization module 98 may assign IDs to the fields of the associated data structs that may be expected to be communicated across a system (e.g., system 100). The assigning of the IDs to the fields may occur before any payload data such as, for example, messages may be communicated (e.g., sent/received) across a system (e.g., system 100). For purposes of illustration and not of limitation, consider the struct User Info (also referred to herein as UserInfo) of FIG. 4. Regarding the left-side of FIG. 4, consider that a message is received by the network device 160 from a node subsequent to the network device 160 receiving the schema(s) (e.g., the first/input schema). The message may include named fields with data types having user info in a field called user id (also referred to herein as userid) of type integer (i) 64 (i64). The message also includes a field called username in a type string. Considering the user id in the message, the binary serialization module 98 may execute a binary serialization protocol which may serialize the data payload, associated with the message, according to the assigned identifiers (e.g., numbers) to fields of the struct User Info and may define a projection of the specified schema in the input to the binary serialization protocol schema (e.g., a second schema) in the output. In this regard, the binary serialization module 98 may have already assigned an ID 1 to a field associated with user id of type i64. The binary serialization module 98 may also have already assigned an ID 2 to a field associated with username of type string. In some example embodiments, the assigning of IDs to the schema (e.g., the first/input schema) associated with the message may be entirely unknown to the node (e.g., communication device 105) associated with sending the message to the network device 160.

In the example of FIG. 4, the binary serialization module 98 may analyze the username and user id data types and may assign and associate them with IDs. For instance, the binary serialization module 98 may assign an ID such as 1 to the user id data type associated with the struct User Info and may assign an ID such as 2 to the username data type associated with the struct User Info. The IDs (e.g., 1, 2) may be indelible numbers such that the association of the user id data type with ID 1 and the association of the username data type with ID 2 may not change for this struct User Info data set. In this manner, the field ID of 1 at the top level of the struct User Info may always denote an integer 64 (also referred to herein as i64) named user id. In an instance in which the binary serialization module 98 may analyze another struct User Info and detects a user id field with type integer 64, the binary serialization module 98 may associate the ID 1 with the other struct User Info.

Suppose, for example, that an application developer determined that assigning the type integer 64 to the field named user id was a mistake. In this regard, presume that the application developer decided to make a change/update and define user id to a string for the struct User Info. This may be a change to a schema definition associated with the struct User Info. In response to detecting this defined change/update, the binary serialization module 98 may determine that a new ID assignment is needed for a string named user id. The binary serialization module 98 may determine the next available ID (which may be the next available number), which may be ID 3 in this example. As such, the binary serialization module 98 may determine that ID 3 is currently associated with a field called user id of type string. In an instance in which the network device 160 receives new messages associated with the same struct User Info, the network device 160 may analyze the messages and if the network device 160 identifies that the type of the data associated with the user id field is string, the binary serialization module 98 may determine that ID 1 associated with integer 64 for a data type called user id is not being used as a primary ID anymore. Instead, the binary serialization module 98 may now determine that the ID 3 is associated with the string field named user id. The binary serialization module 98 may facilitate storage of the data associated with the string named user id associated with ID 3 in a memory device (e.g., RAM 82). For example, the binary serialization module 98 may facilitate storage of the data associated with the string named user id associated with ID 3 in a column in a table stored in the memory device.

As another example, presume that a determination was subsequently made that it was undesirable to define user id as a string and that a developer changed a schema definition to begin using integer 64 as a data type for the field named user id. In this regard, the binary serialization module 98 may revert back to utilizing the associated ID 1 for the user id field with type integer 64 in messages associated with struct User Info and may ignore the string field named user id associated with ID 3. In this manner, the binary serialization module 98 may facilitate evolving (e.g., changes to) of a schema(s).

In some exemplary embodiments, the binary serialization module 98 may implement/execute the schemas based on one or more definitions associated with the schemas which may be associated with application code in one or more computing languages. The binary serialization module 98 may need to analyze the schemas based on the associated schema definitions. For example, in an instance in which a definition(s) (e.g., associated with data types) associated with a schema is changed/updated (e.g., by an application developer), the binary serialization module 98 may execute generated application code (e.g., associated with the data types) to enforce the change(s).

In an exemplary embodiment, the network device 160 may analyze incoming schema changes associated with messages sent from one or more nodes (e.g., communication devices 105, 110, 115, 120) and may consider current schemas (e.g., stored in memory (e.g., RAM 82)) associated with a binary serialization protocol generated by the binary serialization module 98.

In some exemplary embodiments, to implement backward compatibility, the binary serialization module 98 may treat an analyzed ID assigned 1 as an integer 64 associated with a data type user id, and in an instance in which the binary serialization module 98 analyzes an ID assigned 3, the binary serialization module 98 may treat the analyzed ID assigned 3 as a string associated with data type user id. In this regard, the binary serialization module 98 may achieve backward compatibility. In this example, in an instance in which a message has the ID 1 assignment but not the ID 3 assignment, the binary serialization module 98 may still implement/execute the message in a reliable manner. In some exemplary embodiments, the binary serialization module 98 may implement forward compatibility. For example, suppose the UserInfo structure has now evolved to include a new field, and a node (e.g., a sending node) generating/processing this new field is aware of this change, but a data receiver, such as for example network device 160, may be unaware of this change. In this example, consider that a new field named “dob” with type “string” was added to this UserInfo structure. Consider also that a node (e.g., communication device 105) assigned ID 3 to this field. The node may assign other values for this newly added field, but a receiver, such as for example network device 160, of the serialized data may be unaware of this newly added field. In this example, the receiver, such as for example network device 160, may still be able to correctly receive and decode a subset of the payload data associated with the UserInfo structure such that the binary serialization module 98 may recreate a structured object based on the subset of fields it is aware of (e.g., with IDs 1 and 2) and may simply ignore the field assigned ID 3. In other words, the node may be aware of fields 1, 2, 3 and the receiver (e.g., network device 160) may only be aware of fields 1, 2. In this example, in an instance in which the node may send a serialized message (e.g., including data for fields 1, 2, 3), then the receiver may be able to deserialize fields 1, 2 from the serialized message and may ignore field 3 and may create a structured object including values for just fields 1 and 2.

In the exemplary embodiment of FIG. 4, the left side of the diagram may be associated with a user-specified schema (e.g., a schema specified/defined, at least in part, by a developer and sent by a node) and the user-specified schema may include field name and field type. This user-specified schema may be associated with an existing schema model in the system (e.g., system 100), and the binary serialization module 98 may analyze the schema model associated with the input to implement a binary serialization protocol to assign one or more IDs to the data types associated with the struct User Info of the input schema to generate an output schema on the right side of the diagram of FIG. 4 in the manner described above.

Referring now to FIG. 5, a diagram illustrating another ID assignment based on a binary serialization protocol is provided according to an exemplary embodiment. In the example of FIG. 5, a user (e.g., a developer) may facilitate providing, via a node (e.g., communication device 105), an updated schema for the struct User Info which includes a new string field named dob. The binary serialization module 98 may analyze the user provided struct User Info and the stored schema (along with assigned IDs) for the struct User Info. The binary serialization module 98 may determine that the stored schema does not provide an ID for the string field dob and may choose to assign the next available ID (in this case 3) to the string field dob. In this regard, the binary serialization module 98 may assign an ID 1 to integer 64 of data type user id, may assign ID 2 to a string of data type username. Additionally, the binary serialization module 98 may assign ID 3 to a new string of data type. As such, the newly added string of data type dob is assigned ID 3 by the binary serialization module 98 and the new assignment may be an example of struct evolution, e.g., the evolution of new struct fields to a struct type (e.g., struct User Info).

The user may also provide a schema for the struct Country Info (also referred to herein as CountryInfo) and determine that it is newly added to the system (e.g., an application developer may have added a new definition(s) regarding Country Info within the system). The binary serialization module 98 may determine that the schema associated with the struct Country Info is not associated with any IDs and may determine that a string of data type name and a string of data type capital name may be newly added to the struct Country Info. The binary serialization module 98 may assign an ID 1 to the string of data type name which may be associated with one or more country names (e.g., United States of America (USA), Canada, etc.) and may assign ID 2 to a string of data type capital name (e.g., Washington DC, Ottawa, etc.), which may be associated with one or more capitals associated with the countries.

In the struct Table Schema (also referred to herein as TableSchema) of the input message, the binary serialization module 98 may determine that there is an event time, an event name, User Info and a list of Country Info. The Table Schema may be a schema associated with storage of data associated with one or more structs of a message (e.g., an input/output message) in a table of a memory (e.g., RAM 82) by the binary serialization module 98. With reference to the struct Table Schema of FIG. 4, instead of generating a list of strings for countries, the binary serialization module 98, in the example of FIG. 5, determined that the struct Table Schema has a list of Country Info associated with county names and associated capital names corresponding to the newly added struct Country Info which is an evolution (i.e., new), as described above. In the struct Table Schema of FIG. 4 there was a list of strings for countries and in FIG. 5, the binary serialization module 98 generated a list of a data types named Country Info having subfields called name and capital name.

In the example of FIG. 5, the binary serialization module 98 may analyze the struct Table Schema associated with the newly provided schema and determine that the struct Table Schema associated with this schema is not associated with any IDs and may determine that a data type associated with a list of countries were changed (e.g., based on the struct Country Info).

Regarding the struct Table Schema, the binary serialization module 98 may assign an ID 1 to the event time, may assign ID 2 to the string of data type event name. Additionally, the binary serialization module 98 may assign ID 3 to User Info. The ID 3 for User Info remained the same in FIG. 5 as corresponding ID 3 in the struct Table Schema for User Info in FIG. 4. However, in the example of FIG. 5, the binary serialization module 98 assigned the list of Country Info as ID 5 since ID 4 may be already assigned to a list of a string of countries and this list was changed to a list of Country Info including names of countries and associated capital names. The list of countries assigned ID 4 in the struct Table Schema may no longer be used since the list was changed to Country Info including names of countries and associated capital names. In other words, the ID 4 associated with the list of countries may be associated with a previous version of the struct Table Schema. A new list of Country Info was added to the new/current struct Table Schema and the binary serialization module 98 assigned this list as ID 5.

For purposes of illustration and not of limitation, in an instance in which an application developer subsequently decided to change a definition(s) associated with the struct Table Schema to remove the string capital name from struct Country Info and revert back to utilizing the string of list of countries, the binary serialization module 98 may utilize ID 4 again associated with the string of the list of countries (e.g., USA, Canada, etc.). In this manner, the binary serialization module may ignore ID 5 associated with the list of Country Info. This approach enables the binary serialization module 98 to facilitate backward comparability.

Some networks utilizing non-ID based serialization protocols may process an inordinate amount (e.g., more than 2 terabytes (TBs)/second) of messages from nodes associated with one or more systems. In view of the inordinate number/amount of messages, these non-ID based serialization protocol networks may inefficiently consume processing resources of a network device and may increase traffic (e.g., constrain bandwidth) across a network. Additionally, these non-ID based serialization protocol networks may not provide any forward or backward compatibility guarantees either.

However, by utilizing the exemplary embodiments, the binary serialization module 98 may generate data structures in terms of associated names and data types which may be assigned to an identifier (e.g., a numeric ID) that may be used to facilitate transmitting/receiving information across a network in a compact and efficient format. In this regard, based in part on being able to process/read the IDs instead of having to process/read all of the field names and types associated with messages, the exemplary embodiments may conserve processing capacity of a network device (e.g., network device 160), for example by reducing processing consumption to both serialize as well as deserialize messages, may minimize/conserve memory space of memory devices storing the data of messages and/or schemas (e.g., by providing more compact/robust Table Schemas for data) and may minimize data traffic (e.g., conserve bandwidth by reducing bandwidth consumption for transfer of messages) across a network.

Additionally, by utilizing the exemplary embodiments, the data of messages may be interpreted unambiguously and reliably even in instances in which a change(s) in a schema is made, unlike with existing systems which may misinterpret (e.g., the data may be distorted and unintelligible) the data and/or may be unable to recover the data.

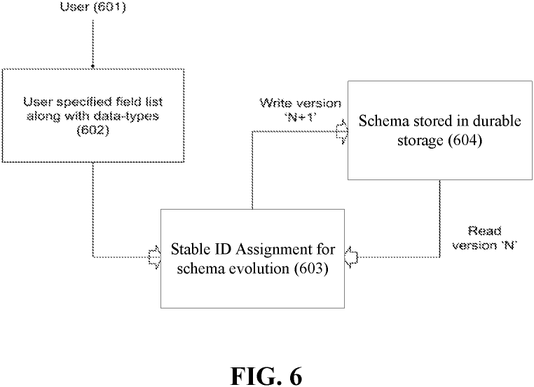

FIG. 6 illustrates an example flowchart illustrating operations for providing stable identifier assignments to one or more schemas according to a binary serialization protocol of an exemplary embodiment. At operation 602, a user (601) (e.g., a developer) may specify a schema(s) including a list of data types such as field name and field type pairs along with the name(s) of the structs that this schema(s), such as for example a first schema, are associated with. These schema(s) may be associated with previously identified struct names and/or previously unidentified/unknown struct names. The schema(s) including the list of data types described above may be received by a network device (e.g., network device 160) from one or more nodes (e.g., communication devices 105, 110, 115, 120).

At operation 603, the binary serialization module 98 of the network device 160 may analyze the fields associated with the first schema and may apply a second schema associated with a binary serialization protocol (e.g., convert a structured object (e.g., data object) into a byte stream) to assign identifiers to the content items to conform the content items to a second schema. The first schema and the second schema may be different. The binary serialization module 98 may perform the analyzing of the fields based in part on determining that the fields (e.g., specified by the user) were not previously associated with one or more identifiers associated with the second schema. The identifiers may be numeric/numbers. The numbers may be represented in a binary format. The identifiers may be assigned to the fields by the binary serialization module 98. The fields may, for example, include one or more data structures (e.g., structs) including one or more types of data and one or more named fields (e.g., field_name, field_type pairs).

At operation 604, the binary serialization module 98 may facilitate storage of the first schema that was converted to the second schema (e.g., a version N+1 of the first schema) and the associated assigned identifiers and the fields in a memory device (e.g., RAM 82) for example according to a struct Table Schema. In some example embodiments, the identifiers and/or fields associated with the first schema that is converted to the second schema may be stored in a table by the binary serialization module 98 and the table may be stored in the memory device (e.g., RAM 82). The binary serialization module 98 may also read the first schema converted to the second schema (e.g., also referred to herein as Read version ‘N’) stored in the memory device. The binary serialization module 98 of the network device 160 may enable sending of items of data (e.g., a new message, a prior message, a currently received message, etc.), assigned one or more identifiers, associated with the second schema to a communication device(s) (e.g., communication devices 105, 110, 115, 120). The network device 160 may receive one or more items of data (e.g., a new input message), from a communication device(s) (e.g., communication devices 105, 110, 115, 120), associated with the second schema and associated with the content items (e.g., a prior output message) assigned the identifiers.

The binary serialization module 98 may assign a new identifier (e.g., ID 5 in the struct Table Schema of FIG. 5) to at least one new data structure, i.e., a struct(s), associated with the fields in response to determining there is an update/change to the data structure (e.g., a list of Country Info (including country names and capitals)) of the fields (e.g., specified by the user 601). In this example, the fields (e.g., of the new input message) and the fields (e.g., of the prior output message) may be associated with the second schema (e.g., a schema associated with a binary serialization protocol).

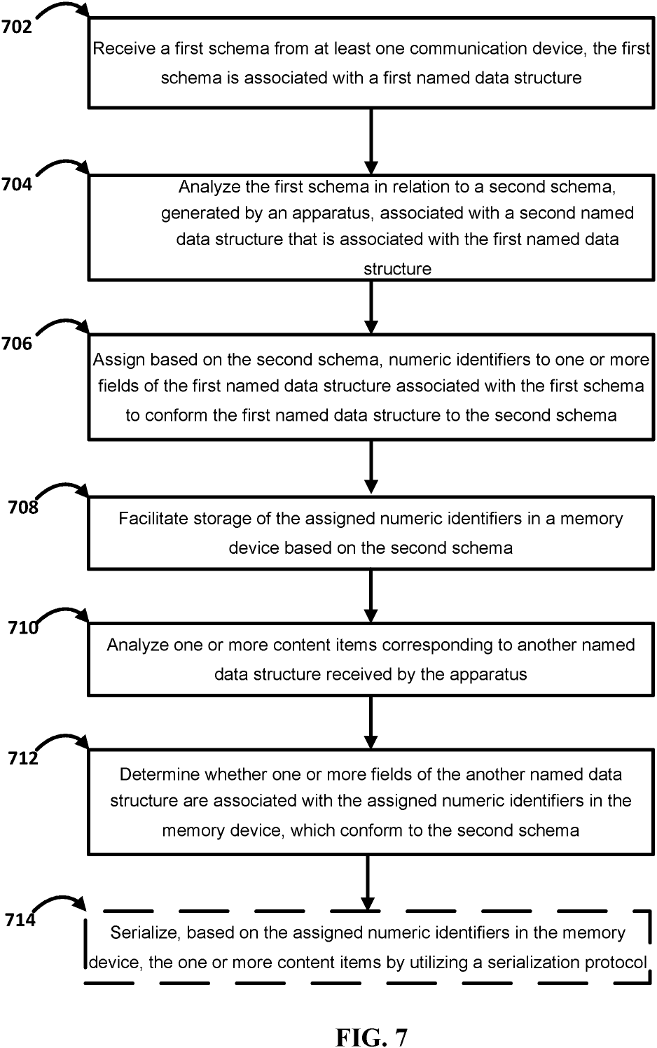

FIG. 7 illustrates another example flowchart illustrating operations for providing stable identifier assignments to one or more schemas according to a binary serialization protocol of another exemplary embodiment. At operation 702, an apparatus (e.g., a binary serialization module 98 of a network device 160) may receive a first schema from at least one communication device (e.g., communication device 105, communication device 110, etc.). The first schema may be associated with a first named data structure. At operation 704, an apparatus (e.g., a binary serialization module 98) may analyze the first schema in relation to a second schema, generated by the apparatus, associated with a second named data structure that is associated with the first named data structure.

At operation 706, an apparatus (e.g., a binary serialization module 98) may assign based on the second schema, numeric identifiers (e.g., IDs) to one or more fields of the first named data structure associated with the first schema to conform/convert the first named data structure to the second schema. In some example embodiments, the apparatus may assign the numeric identifiers to the one or more fields of the first named data structure associated with the first schema to conform the first named data structure to the second schema in an instance in which the one or more fields are initially unassigned any identifiers. At operation 708, an apparatus (e.g., a binary serialization module 98) may facilitate storage of the assigned numeric identifiers in a memory device (e.g., RAM 82) based on the second schema. At operation 710, an apparatus (e.g., a binary serialization module 98) may analyze one or more content items corresponding to another named data structure received by the apparatus. In some example embodiments, the content items may be associated with payload data (e.g., messages).

At operation 712, an apparatus (e.g., a binary serialization module 98) may determine whether one or more fields of the another named data structure are associated with the assigned numeric identifiers in the memory device, which conform to the second schema. Optionally, at operation 714, an apparatus (e.g., a binary serialization module 98) may serialize, based on the assigned numeric identifiers in the memory device, the one or more content items by utilizing a serialization protocol.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving, by a network device, a first schema from at least one communication device, the first schema associated with a first named data structure;
analyzing the first schema in relation to a second schema, generated by the network device, associated with a second named data structure associated with the first named data structure;
assigning, based on the second schema, numeric identifiers to one or more fields of the first named data structure associated with the first schema to conform the first named data structure to the second schema, resulting in assigned numeric identifiers;
facilitating storage of the assigned numeric identifiers in a memory device based on the second schema;
analyzing one or more content items corresponding to another named data structure received by the network device; and
determining whether one or more fields of the another named data structure are associated with the assigned numeric identifiers in the memory device, which conform to the second schema.

2. The method of claim 1, further comprising:
serializing, based on the assigned numeric identifiers in the memory device, the one or more content items by utilizing a serialization protocol.

3. The method of claim 1, wherein the analyzing further comprises determining that the first schema was not previously associated with one or more identifiers associated with the second schema.

4. The method of claim 2, wherein prior to the serializing, the method further comprises:
assigning at least one corresponding numeric identifier from the assigned numeric identifiers to at least one data field of the another named data structure in response to determining that the at least one data field is previously unassociated with one or more of the assigned numeric identifiers.

5. The method of claim 1, wherein the first schema is defined, in part, by at least one user.

6. The method of claim 1, wherein the one or more content items comprise at least one message.

7. The method of claim 1, wherein the first schema and the second schema are different.

8. The method of claim 1, wherein at least one of the first named data structure, the second named data structure or the another named data structure comprise one or more types of data and one or more named fields.

9. The method of claim 8, further comprising:
receiving items of data, from the at least one communication device, associated with the second schema and associated with one or more of the assigned numeric identifiers; and
determining whether there is an update to at least one data structure of the items of data in relation to the second named data structure associated with the second schema.

10. The method of claim 9, wherein the items of data and the content items are associated with the second schema.

11. A system comprising:
a device comprising one or more processors; and
at least one memory storing instructions, that when executed by the one or more processors, cause the device to:
receive a first schema from at least one communication device, the first schema associated with a first named data structure;
analyze the first schema in relation to a second schema, generated by the device, associated with a second named data structure associated with the first named data structure;
assign, based on the second schema, numeric identifiers to one or more fields of the first named data structure associated with the first schema to conform the first named data structure to the second schema, resulting in assigned numeric identifiers;
facilitate storage of the assigned numeric identifiers in the at least one memory based on the second schema;
analyze one or more content items corresponding to another named data structure received by the device; and
determine whether one or more fields of the another named data structure are associated with the assigned numeric identifiers in the at least one memory, which conform to the second schema.

12. The system of claim 11, wherein when the one or more processors further execute the instructions, the device is configured to:
serialize, based on the assigned numeric identifiers in the at least one memory, the one or more content items by utilizing a serialization protocol.

13. The system of claim 11, wherein when the one or more processors further execute the instructions, the device is configured to:
analyze the one or more content items by determining that the first schema was not previously associated with one or more identifiers associated with the second schema.

14. The system of claim 12, wherein prior to the serialize, when the one or more processors further execute the instructions, the device is configured to:
assign at least one corresponding numeric identifier from the assigned numeric identifiers to at least one data field of the another named data structure in response to determining that the at least one data field is previously unassociated with one or more of the assigned numeric identifiers.

15. The system of claim 11, wherein the first schema is defined, in part, by at least one user.

16. The system of claim 11, wherein the one or more content items comprise at least one message.

17. The system of claim 11, wherein the first schema and the second schema are different.

18. The system of claim 11, wherein at least one of the first named data structure, the second named data structure or the another named data structure comprise one or more types of data and one or more named fields.

19. A computer-readable medium storing instructions that, when executed, cause:
receiving, by a network device, a first schema from at least one communication device, the first schema associated with a first named data structure;
analyzing the first schema in relation to a second schema, generated by the network device, associated with a second named data structure associated with the first named data structure;
assigning, based on the second schema, numeric identifiers to one or more fields of the first named data structure associated with the first schema to conform the first named data structure to the second schema, resulting in assigned numeric identifiers;
facilitating storage of the assigned numeric identifiers in the computer-readable medium or a memory device based on the second schema;
analyzing one or more content items corresponding to another named data structure received by the network device; and
determining whether one or more fields of the another named data structure are associated with the assigned numeric identifiers in the computer-readable medium or the memory device, which conform to the second schema.

20. The computer-readable medium of claim 19, wherein the instructions, when executed, further cause:
serializing, based on the assigned numeric identifiers in the computer-readable medium or the memory device, the one or more content items by utilizing a serialization protocol.
